(19) United States
(12) Patent Application Publication
(10) Pub. No.: US 2018/0326914 A1
(43) Pub. Date: Nov. 15, 2018

(54) SUPPORT STRUCTURE FOR VEHICLE SEATS

(71) Applicant: JAGUAR LAND ROVER LIMITED, Warwickshire (GB)

(72) Inventors: Lauren COYLE, Coventry (GB); Mike HORSBURGH, Coventry (GB); Stefano LONGOBARDI, Coventry (GB); Richard HARRY, Coventry (GB); Andrew ROBINSON, Coventry (GB); Christopher BROWN, Coventry (GB); Ben COOK, Coventry (GB); Plamen PETROV, Coventry (GB)

(21) Appl. No.: 15/975,965

(22) Filed: May 10, 2018

(30) Foreign Application Priority Data
May 11, 2017 (GB) 1707534.2

(51) Int. Cl. B60R 7/04; B60N 2/01; B60N 2/68

(52) U.S. Cl. CPC B60R 7/043; B60N 2/68; B60N 2/01

(57) ABSTRACT

Embodiments of the present invention provide a support structure for a vehicle seat comprising an integrated storage cavity, which may be used to store personal items such as an umbrella. The support structure comprises a reinforcement structure and a moulding, the reinforcement structure being located at least partially within the moulding.

### CROSS REFERENCE TO RELATED APPLICATIONS

This application claims priority to UK Patent Application No. GB1707534.2, filed on 11 May 2017.

### TECHNICAL FIELD

The present invention relates to support structures for vehicle seats, particularly, but not exclusively to support structures for second and third row seats. Aspects of the invention relate to a support structure for a vehicle seat, to a system and to a vehicle.

### BACKGROUND

Conventional seating arrangements for rear (e.g. second or third row) seats of vehicles comprise a cushion having a sheet metal base with a padded portion mounted thereon. The cushion is conventionally mounted to an appropriate location on the vehicle body so as to form an approximately, although usually not exactly, horizontal bench portion of the rear seats, on which the rear passengers may sit.

It is also known to provide a support structure between the vehicle body and the cushion, for example to provide a higher seating position. Such a support structure may be mountable to the vehicle body and may define a location at which the base of the cushion may be mounted to the support structure.

Known support structures are provided solely to provide an appropriate location for mounting the cushion.

It is an object of embodiments of the invention to address disadvantages associated with the prior art.

### SUMMARY

According to an aspect of the invention for which protection is sought there is provided a support structure for a vehicle seat, the support structure comprising a moulding and a reinforcement structure, the reinforcement structure being located at least partially within the moulding, wherein a storage cavity is provided in the support structure, and wherein the reinforcement structure comprises at least one compression portion, the compression portion being contained within the moulding; wherein the compression portion is arranged to be compressed between the body of the vehicle and the seat cushion if the seat cushion is compressed towards the body of the vehicle by more than a predetermined amount.

Advantageously, such a support structure is able to provide a convenient location for a vehicle user to store personal items, without compromising crash performance of a seating arrangement in which is installed. Furthermore such a compression portion may increase the strength and stiffness of the support structure.

In an embodiment the reinforcement structure comprises a metal wireframe. Such a wireframe may provide a lightweight structure that significantly increases the compression stiffness and strength of the support structure.

In an embodiment the moulding comprises expanded polypropylene (EPP), optionally EPP with a density of 40-80 kg/m³, preferably EPP with a density of 55-60 kg/m³. This may provide a good balance between light weight and high strength and stiffness.

In an embodiment the reinforcement structure comprises at least one bracket located outside the moulding. The at least one bracket may comprise a first bracket configured to be connected to a body of the vehicle. Alternatively or in addition, the at least one bracket may comprise a second bracket configured to be connected to a portion of the vehicle seat. Such brackets may ensure that a vehicle seat that is supported by the support structure is secured relative to the vehicle body, so that relative movement between the seat and the vehicle body does not occur during a crash. Optionally, the at least one bracket is connected to the reinforcement structure. This may ensure that the connection between the bracket and the support structure is strong. Indeed, in some embodiments the bracket and the reinforcement structure may be integrally formed with each other.

In an embodiment the reinforcement structure comprises at least one thin-walled portion. A portion may be considered to be thin-walled if it has a thickness that is not more than 25%, preferably not more than 10%, of the width and length of the portion.

In an embodiment one or more apertures are formed in the thin-walled portion. Advantageously, the one or more apertures allow the material of the moulding to pass through the thin-walled portions, thereby ensuring that a strong connection is provided between the moulding and the reinforcement structure.

Optionally, the thin-walled portion comprises a first planar section located within the moulding near an upper surface of the moulding and a second planar section located within the moulding near a lower surface of the moulding, and a connecting portion between the first and second planar sections. The thin-walled portion may comprise a C-shaped bracket. Advantageously, such a thin-walled portion may increase the stiffness and strength of the support structure, especially when the support structure is subjected to large loads as would be the case when the support structure is supporting an occupied seat during a crash.

In an embodiment the support structure comprises a plurality of thin-walled portions.

Optionally the compression portion comprises a thin-walled portion.

In an embodiment the cavity has first and second transverse ends and one of said compression portions is located in the moulding proximate each of the first and second transverse ends.

In an embodiment the storage cavity has a maximum length of at least 90 cm, preferably at least 95 cm. Optionally, the storage cavity has a depth of at least 15 cm. Advantageously, this may allow the storage cavity to be used for storage of relatively long personal items, for example umbrellas.

In an embodiment the storage cavity comprises a front portion and at least one rearward portion, the front portion being located between an opening of the storage cavity and the rearward portion. Optionally the front portion may have a maximum length of at least 90 cm, preferably at least 95 cm, and the maximum length of the rearward portion may be less than the maximum length of the front portion. The front and rearward portions may be suitable for storing different items.

In an embodiment the storage cavity comprises at least two of said rearward portions. Advantageously, a dividing wall between said rearward portions may provide increase the stiffness and strength of the support structure. Furthermore, providing two separate rearward cavities may enable vehicle users sat in different seats to each use their own storage cavity. In an embodiment one of said compression portions is located in the moulding between said rearward portions.

According to another aspect of the invention for which protection is sought there is provided a system comprising a support structure as described above and a vehicle seat cushion.

In an embodiment the vehicle seat cushion comprises a sheet metal base portion.

According to another aspect of the invention for which protection is sought there is provided a vehicle comprising a system as described above. In an embodiment the system forms a bench portion of a second or third row seating arrangement.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIG. 1 shows a vehicle seating arrangement in an embodiment of the present invention;

FIGS. 2A-C show different views of a support structure for a vehicle seat in an embodiment of the present invention;

FIG. 3 shows a reinforcement structure for a support structure in an embodiment of the present invention;

FIG. 4 shows the location of the reinforcement structure shown in FIG. 3 within the support structure shown in FIGS. 2A-C;

FIGS. 5A-B show a support structure attached to a cushion of a vehicle seat in an embodiment of the present invention;

FIG. 6 shows an interior floor of the rear portion of a vehicle, into which a support structure in an embodiment of the present invention may be mounted; and

FIG. 7 shows a vehicle into which a support structure in an embodiment of the present invention may be mounted.

### DETAILED DESCRIPTION

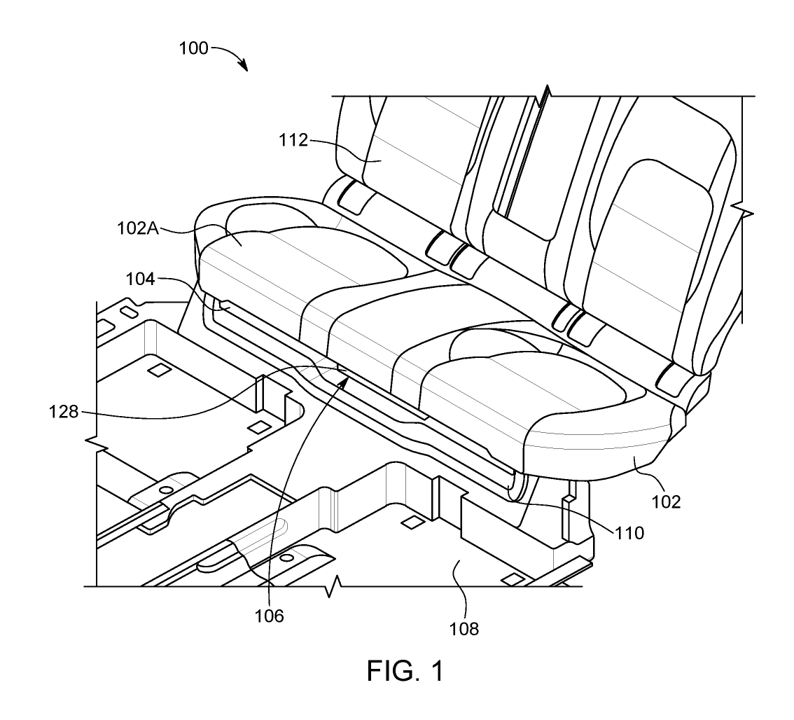

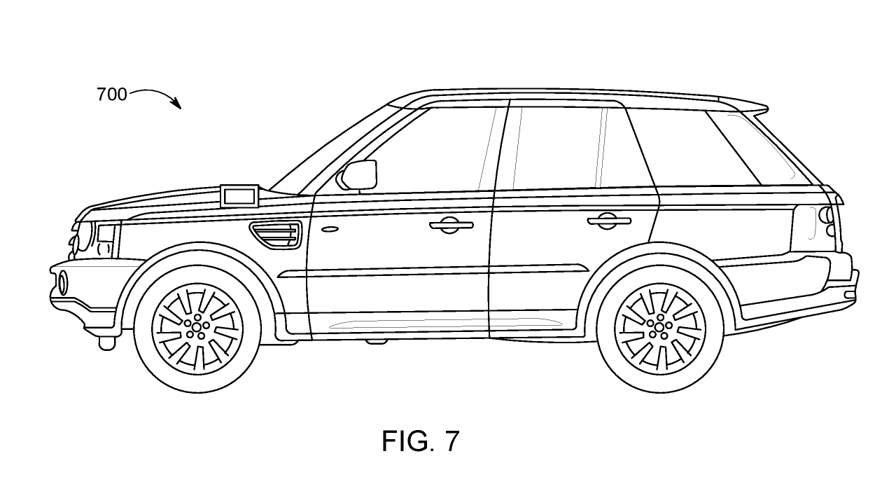

FIG. 1 shows a vehicle seating arrangement 100 of an embodiment of the present invention. It will be understood that the seating arrangement 100 may be incorporated into a vehicle 700 as shown in FIG. 7.

The seating arrangement 100 comprises a cushion 102 having an upper surface 102A that is approximately horizontal so as to allow a passenger to be able to sit on it. The seating arrangement 100 also comprises a seat back portion 112 on which a passenger may rest their back when sitting on the cushion 102. As can be seen in FIG. 1, the cushion 102 is mounted on a support structure 104 that includes a storage cavity 106. The support structure 104 is in turn mounted onto the rear floor 108 of the vehicle body, so that the cushion 102 is firmly held in place. In FIG. 1 the support structure 104 is partially covered by a decorative trim 110.

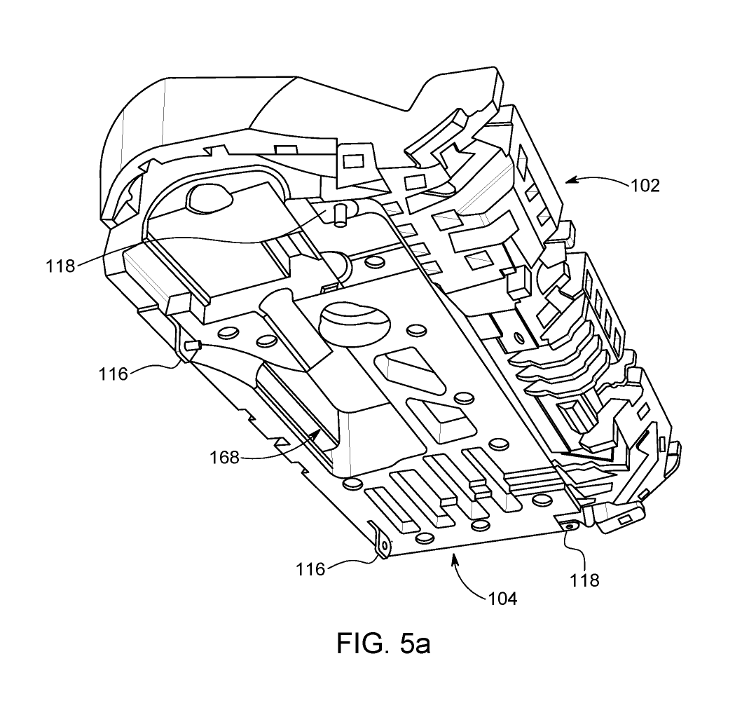

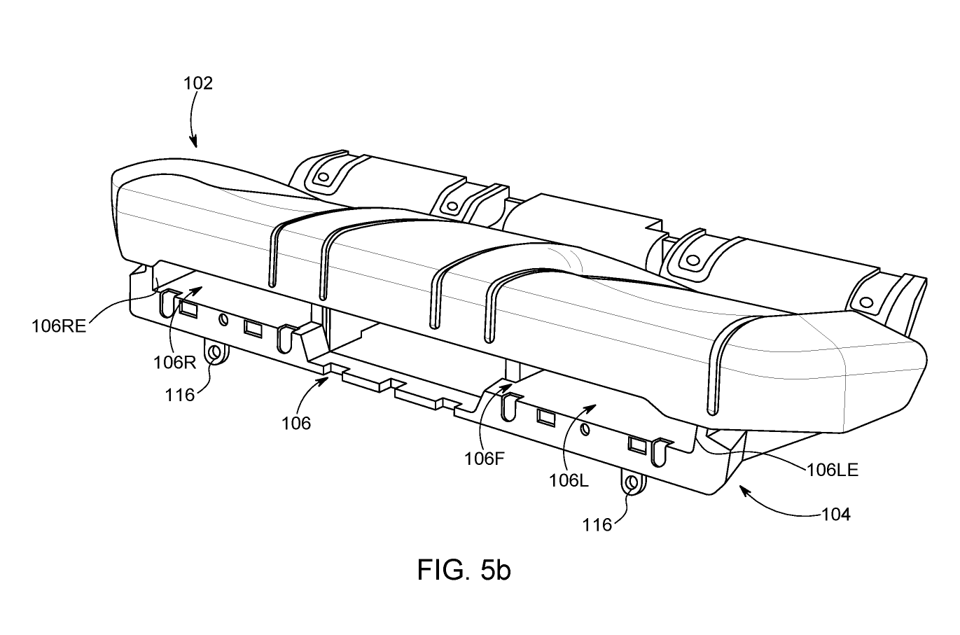

The storage cavity 106 advantageously provides a convenient location in which a vehicle user may store personal items such as, for example, tablet or laptop computers, mobile phones, newspapers, documents or umbrellas. Indeed, as best seen in FIG. 5B, the storage cavity of the illustrated embodiment has a front portion 106F. The front portion 106F comprises an uninterrupted length (i.e. a distance between transverse ends 106RE and 106LE) of, for example, approximately 1 m (e.g. 94.8 cm), a depth of, for example, approximately 5 cm (e.g. 5.3 cm) and a height of, for example, approximately 10 cm (e.g. 8.1 cm). Accordingly, the front portion 106F is large enough to accommodate a standard full-length umbrella in its folded configuration. Such an umbrella may have a length of approximately 80-95 cm and a diameter of approximately 5 cm.

The storage cavity of the illustrated embodiment also comprises two side portions 106L, 106R behind the front portion 106F. Each of the side portions 106R, 106L may have a depth of, for example, approximately 15-20 cm (e.g. 16.7 cm), an uninterrupted width of, for example, approximately 30 cm (e.g. 28.8 cm) and a height that tapers from, for example, approximately 8 cm at the opening of the side portion 106R, 106L to, for example, approximately 5 cm at a distal end of the side portion 106R, 106L. Accordingly, the side portions 106L, 106R may provide a convenient location in which documents, newspapers, tablet computers or laptop computers may be stored. It will be understood that items stored in the side portions 106R, 106L may protrude into the front portion 106F, as there is no physical barrier at the front of the side portions 106R, 106L.

It will be appreciated that the configuration and dimensions described above are not definitive, and the storage cavity may be provided with various different configurations and dimensions as desired in alternative embodiments.

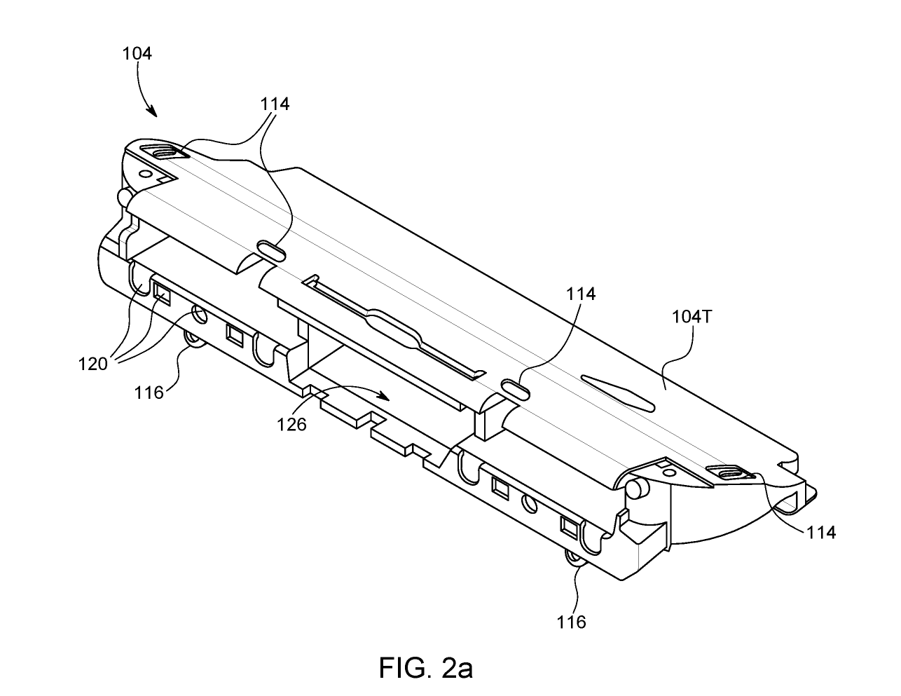

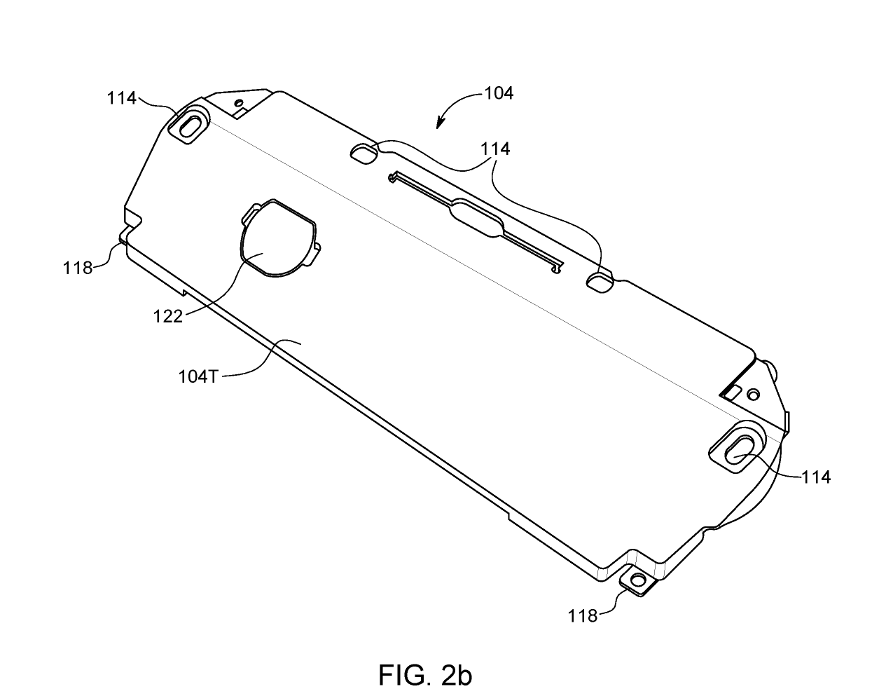

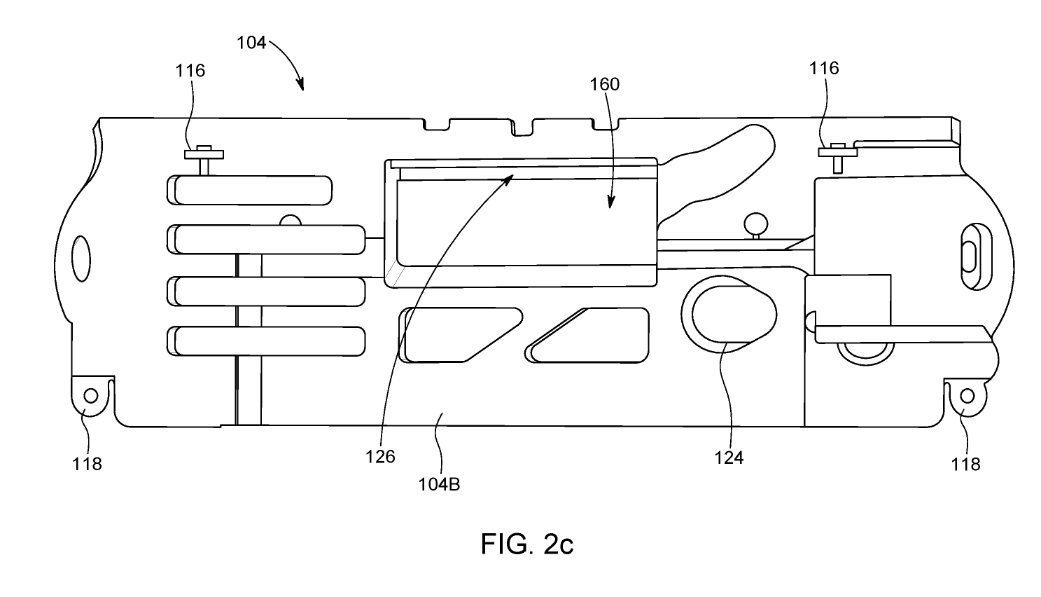

FIGS. 2A and 2B show views of the support structure 104 including a top surface 104T on which the cushion 102 is supported. In the illustrated embodiment, mounting brackets 114 are provided on the top surface 104T to connect to a base of cushion 102. The mounting brackets 114 may be arranged to connect to the cushion 102 in any appropriate manner, as will be well understood by the skilled person. The support structure 104 of the illustrated embodiment is also provided with fixing brackets 116 through which the support structure 104 may be bolted to, for example, the heel board of the vehicle body and fixing brackets 118 through which the support structure 104 may be bolted to, for example, the rear floor of the vehicle body.

As best seen in FIG. 2A, the support structure 104 of the illustrated embodiment is provided with a plurality of recesses 120, into which protrusions of decorative trim 110 may be inserted to effect a releasable connection between the support structure 104 and the decorative trim 110.

The top surface 104T of the support structure 104 may also be provided with a cap 122 which can be opened to provide access through the support structure 104 via through hole 124 (as best seen in FIG. 2C). This may provide access to a switch which may only require access when the vehicle 700 is being serviced. In the illustrated embodiment the cap 122 provides access to an isolation switch of an electric vehicle, but it will be understood that a cap 122 could be used to provide access to other vehicle controls.

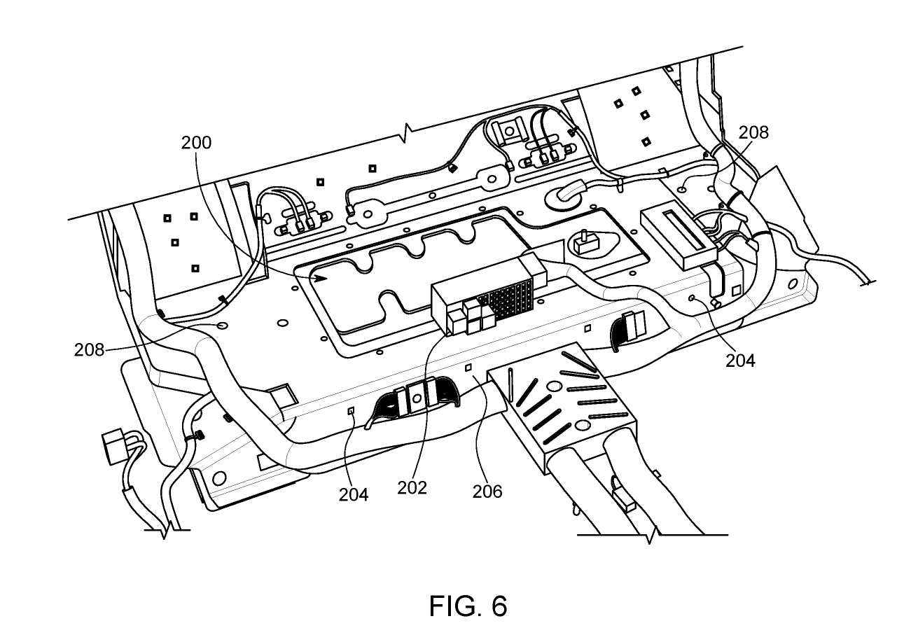

In the illustrated embodiment, the support structure 104 is also provided with an opening 126 in a central region of the base of the storage cavity. In use the opening 126 may be covered by a door 128, as shown in FIG. 1. The opening 126 can provide access to a vehicle component cavity 168 which is arranged to house any component that does not require regular access, but that it may be necessary for the vehicle users to periodically access. For example, the opening 126 may provide access to the passenger junction box (PJB) 202 illustrated in FIG. 6.

As the support structure 104 is to be positioned between the seat cushion 102 and the vehicle body floor 108 it is necessary to ensure that the support structure 104 does not collapse or move significantly under the loading that occurs during a crash event, as movement or collapse of the support structure 104 during a crash event could cause the phenomenon known as “submarining” to occur. As will be well understood by the skilled person, submarining occurs when the loading during a crash causes the seat a user is sat on to move or collapse so that the user moves in a downward direction relative to the vehicle body. This causes the user's seatbelt to ride up to a higher position on the user, which can increase the likelihood of the user being injured.

Furthermore, as there is a requirement to make vehicles more energy efficient it is desirable that the support structure 104 should be as light as possible without compromising crash safety.

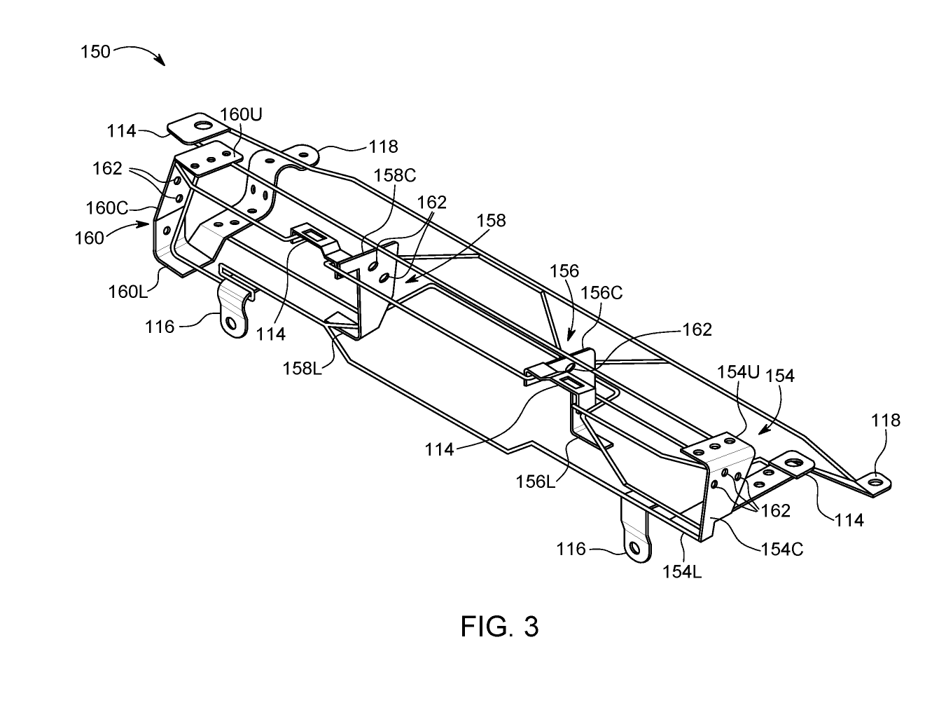

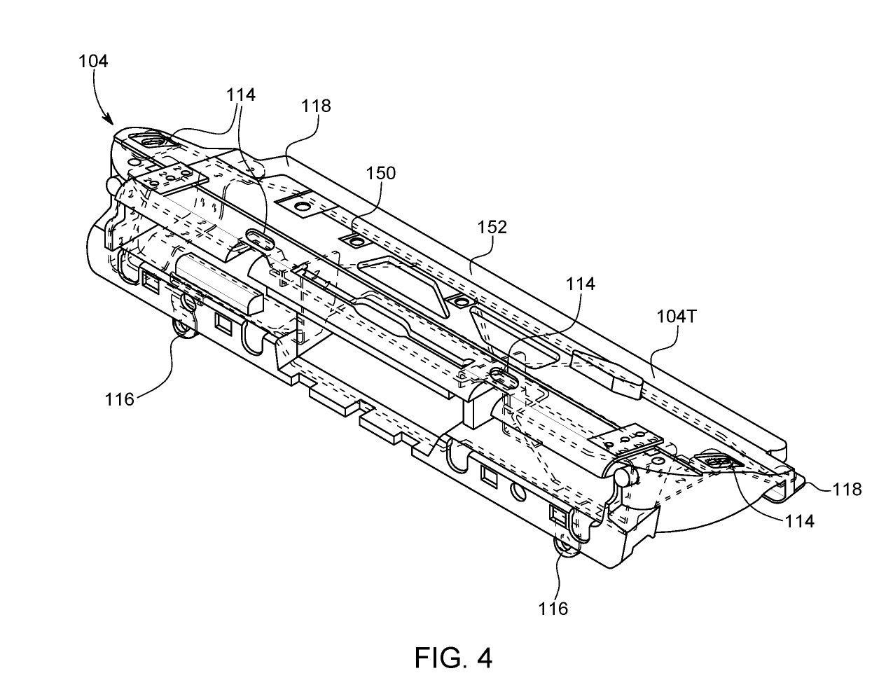

To achieve the required combination of lightness and strength the support structure 104 comprises a moulding and a reinforcement structure, the reinforcement structure being located at least partially within the moulding. FIG. 3 shows an example of the reinforcement structure 150, and FIG. 4 shows an example of the support structure 104 within the moulding 152 in ghost outline such that the location of the reinforcement structure 150 within the moulding 152 can be seen.

The moulding 152 may be made from a thermoplastic polymer such as, for example, expanded polypropylene (EPP) having a density of, for example, 55-60 kg/m³. However, it will be understood that EPP with a different density or different materials would also be suitable.

The reinforcement structure 150 may be made from, for example, steel and in the illustrated embodiment comprises a wireframe with a plurality of thin-walled portions 154, 156, 158, 160 connected thereto. It will be understood that other materials, especially other metals, and alternative structural configurations would also be suitable for use in the manufacture of the reinforcement structure 150.

In the illustrated embodiment, each of the thin-walled portions 154, 156, 158, 160 is provided with a plurality of through holes 162, which holes 162 are provided to allow the EPP to pass through the thin-walled portions 154, 156, 158, 160 during the moulding process, thereby enhancing the adhesion between the moulding 152 and the thin-walled portions 154, 156, 158, 160 of the reinforcement structure 150.

A particular advantage of providing a metal reinforcement structure 150 within a moulding 152 is that it allows the parts that are used in connecting the support structure 104 to other components, such as to a seat cushion 102 or vehicle body, to be formed on the reinforcement structure 150. In the illustrated embodiment the fixing brackets 116, 118 and mounting brackets 114 are all formed as parts of the reinforcement structure 150 that are arranged to protrude outside the moulding 152 when the support structure 104 is formed. As the fixing brackets 116, 118 and the mounting brackets 114 are formed as part of the support structure 104, which is partially contained within the moulding 152, a strong connection between the fixing brackets and mounting brackets and support structure 104, including the moulding 152, is provided.

It will be understood that the reinforcement structure 150 increases the stiffness and strength of the support structure 104. Although the wireframe and thin-walled portions 154, 156, 158, 160 are relatively thin, and therefore do not add a significantly amount to the weight of the support structure 104, they are resistant to buckling under normal or crash loading because of the presence of the moulding 152 around them, which provides them with additional support to resist buckling.

The thin-walled portions 154, 156, 158, 160 may be especially important in ensuring that the support structure 104 is capable of withstanding crash loading without allowing “submarining” of vehicle users sat on a cushion 102 supported by the support structure 104.

In the illustrated embodiment, thin-walled portions 154 and 160 comprise C-shaped fixing brackets located in the moulding 152 close to the respective transverse ends 106LE, 106RE of the front portion 106F of the cavity. Thin-walled portions 154, 160 each have an upper planar section 154U, 160U a lower planar section 154L, 160L and a connecting portion 154C, 160C. As can be seen in FIG. 4, the upper portions 154U, 160U, the lower portions 154L, 154U and the connecting portions 154C, 160C are all located within the moulding 152, with the upper and lower portions located close to the upper and lower surfaces of the support structure 104. Accordingly, when the support structure 104 is subjected to a large compressive force, as is typically the case during a crash event when a user is sat on a seat supported by the support structure 104, the upper and lower portions 154U, 160U, 154L, 160L are urged against the base of the cushion 102 and the vehicle body floor 108, respectively. Under such high loading the compression resistance of the portion of the EPP moulding is relatively low, so a substantial proportion of the load is transmitted via the thin-walled portions 154, 160, which have higher stiffness and strength than the EPP moulding per se. It will be understood that under normal loading conditions the EPP moulding itself may be sufficiently strong to transmit the loads occurring as a result of a user sitting on the seat 102 to the vehicle body without undergoing significant deformation. Accordingly, the thin-walled portions may not transmit a significant proportion of the load under normal loading conditions.

The reinforcement structure 150 also comprises thin-walled portions 156, 158, located in the moulding 152 between the rearward portions 106R, 106L of the cavity 168. The thin-walled portions 156, 158 are each provided with lower planar portions 156L, 158L, which lower planar portions are located within the moulding 152 near a lower surface of the support structure 104. The lower planar portions 156L, 158L are each connected to respective centrally located mounting brackets 114 via connecting portions 156C. Accordingly, when the support structure 104 is subjected to a high compressive load as is likely to be the case during a crash event when a user is sat on a cushion that is supported by the support structure 104, the lower planar portions 156L, 158L are urged against (directly or via a part of the moulding) the vehicle body floor 108, whilst the centrally located mounting brackets 114 are urged against the base of the cushion 102. As the resistance to compression of the material that the moulding 152 is made from may be too low to withstand the compressive loads that are present during crashes, a significant proportion of the load that exists between the seat cushion 102 (which is directly connected to the thin-walled portions 156, 158 via the centrally located mounting brackets 114) is transmitted via the thin-walled portions 156, 158 to the vehicle body floor.

Although a large proportion of any large compressive load is transmitted via the thin-walled portions in the illustrated embodiment, it will be understood that it would also be possible to provide other parts within the reinforcement structure 150 for bearing large compressive loads and therefore preventing collapse of the support structure 104 under crash loading. Parts for bearing large compressive loads may be referred to as “compression portions”, and such compression portions may be located within the moulding 152 with ends close to the upper and lower surfaces of the moulding 152. This may allow the compression portion to be compressed between the body of the vehicle and the seat cushion 102 when the support structure 104 is subjected to large compressive loads.

Moving on to FIGS. 5A and 5B, it can be seen that the seat cushion 102 may be secured to the support structure 104 via mounting brackets 114, which may subsequently be connected to the vehicle body via fixing brackets 116, 118. It will be understood that fixing brackets 116 may not be placed under tension when the support structure 104 is first connected to the vehicle body. Instead, the fixing brackets 116 may only be subjected to tension when the seat cushion 102 is subjected to high loads as would be the case during a crash. In this way the fixing brackets 118 may prevent the seat cushion 102 from sliding forward during a crash. It will be understood that the seat cushion 102 sliding forward during a crash may lead to “submarining” of an occupant of the seat, as described above.

FIG. 6 shows the location 200 within a vehicle body where the support structure 104 may be attached to a vehicle 700. The fixing brackets 116 may be attached to the heel board 206 at mounting points 204, and the fixing brackets 118 may be attached to the vehicle body floor via mounting points 208. When the support structure 104 is attached to the vehicle body the PJB 202 is located within vehicle component cavity 168.

It will be understood that the support structure 104 of the present invention may be manufactured by known moulding techniques, for example injection moulding or compression steam chest moulding. The reinforcement structure 150 may be placed in the mould before the material of the moulding (e.g. EPP) is introduced to the mould, thereby to form a final part having a reinforcement structure at least partially located within a moulding.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A support structure for a vehicle seat, the support structure comprising:
a moulding;
a reinforcement structure;
the reinforcement structure being located at least partially within the moulding;
a storage cavity provided in the support structure; and
wherein the reinforcement structure comprises at least one compression portion contained within the moulding;
wherein the compression portion is arranged to be compressed between the body of a vehicle and a seat cushion if the seat cushion is compressed toward the body of the vehicle by more than a predetermined amount.

2. A support structure as claimed in claim 1, wherein the reinforcement structure comprises a metal wireframe.

3. A support structure as claimed in claim 1, wherein the reinforcement structure comprises at least one bracket located outside the moulding.

4. A support structure as claimed in claim 3, wherein the at least one bracket comprises at least one fixing bracket configured to be connected to the body of the vehicle.

5. A support structure as claimed in claim 3, wherein the at least one bracket comprises at least one mounting bracket configured to be connected to a portion of the vehicle seat.

6. A support structure as claimed in claim 3, wherein the at least one bracket is connected to a portion of the reinforcement structure.

7. A support structure as claimed in claim 1, wherein the reinforcement structure comprises at least one thin-walled portion.

8. A support structure as claimed in claim 7, wherein one or more apertures are formed in the at least one thin-walled portion.

9. A support structure as claimed in claim 7, wherein the at least one thin-walled portion comprises a first planar section located within the moulding near an upper surface of the moulding and a second planar section located within the moulding near a lower surface of the moulding, and a connecting portion between the first and second planar sections.

10. A support structure as claimed in claim 9, wherein the at least one thin-walled portion comprises a C-shaped bracket.

11. A support structure as claimed in claim 7, wherein the at least one thin-walled portion comprises a plurality of thin-walled portions.

12. A support structure as claimed in claim 1, wherein the storage cavity has first and second transverse ends and the at least one compression portion is located in the moulding proximate each of the first and second transverse ends.

13. A support structure as claimed in claim 12, wherein the at least one compression portion comprises a thin-walled portion of the reinforcement structure.

14. A support structure as claimed in claim 1, wherein the storage cavity comprises a front portion and at least one rearward portion, the front portion being located between an opening of the storage cavity and the at least one rearward portion.

15. A support structure as claimed in claim 14, wherein the storage cavity comprises at least two of said rearward portions.

16. A support structure as claimed in claim 15, wherein the at least one compression portion is located in the moulding between said rearward portions.

17. A system comprising:
a vehicle seat cushion;
a moulding;
a reinforcement structure;
the reinforcement structure being located at least partially within the moulding;
a storage cavity provided in the support structure; and
wherein the reinforcement structure comprises at least one compression portion contained within the moulding;
wherein the compression portion is arranged to be compressed between the body of a vehicle and the vehicle seat cushion if the vehicle seat cushion is compressed toward the body of the vehicle by more than a predetermined amount.

18. A system as claimed in claim 17, wherein the vehicle seat cushion comprises a sheet metal base portion.

19. A vehicle comprising a system as claimed in claim 17.

20. A vehicle as claimed in claim 19, wherein the vehicle includes a second or third row seating arrangement and the system forms a bench portion of the second or third row seating arrangement.
